(19) United States
(12) Patent Application Publication
(10) Pub. No.: US 2022/0137771 A1
(43) Pub. Date: May 5, 2022

(54) TOUCH PANEL, TOUCH SCREEN AND DISPLAY DEVICE

(71) Applicant: SHENZHEN ROYOLE TECHNOLOGIES CO., LTD., Shenzhen (CN)

(72) Inventor: Ruichun Liu, Shenzhen (CN)

(21) Appl. No.: 17/423,121

(22) PCT Filed: Jan. 15, 2019
(86) PCT No.: PCT/CN2019/071811

§ 371 Date: Jul. 15, 2021

(51) Int. Cl. G06F 3/041; G06F 3/044

(52) U.S. Cl. CPC G06F 3/04164; G06F 3/0445; G06F 3/0446

(57) ABSTRACT

Provided are a touch panel, a touch screen and a display device, wherein the touch panel includes a substrate and touch electrodes provided on the substrate, the touch panel is divided into at least two split screen areas, the touch electrodes in the adjacent split screen areas are respectively provided on two opposite surfaces of the substrate. The technical solution can reduce the difference between the lengths of the frame wiring by using the split screen and split screen wiring method, so as to prevent serious signal attenuation caused by the long line, and to effectively reduce the signal interference, the problem that the prior touch screen has low touch sensitivity is alleviated, and the touch sensitivity is improved. In addition, the touch panel can use the substrate with high impedance, which improves the display effect.

### TECHNICAL FIELD

The present disclosure relates to the technical field of display equipment, and in particular to a touch panel, a touch screen and a display device.

### BACKGROUND ART

A touch screen is a sensing device that can receive touch input signals and can be used to replace a mechanical button-type display panel. As a touch input device, the touch screen provides users with the simplest, convenient and natural way of human-computer interaction, which facilitates user operations and improves user experience.

At present, touch screens mostly are in single-layer multi-point touch screen structure, because of the cost and thickness advantages of single-layer multi-point touch screen structure. However, due to the twists and turns of the wiring and the very large difference between the lengths of the wirings between different channels, the signal attenuation is severe, resulting in low touch sensitivity of the touch screen.

In summary, the existing touch screen has the problem of low touch (touch control) sensitivity.

### SUMMARY

In view of this, the purpose of the present disclosure includes providing a touch panel, a touch screen, and a display device to alleviate the technical problem of low touch sensitivity in the prior art.

In a first aspect, an embodiment of the present disclosure provides a touch panel, including a substrate and touch electrodes disposed on the substrate, wherein the touch panel is divided into at least two partitions and the touch electrodes in adjacent partitions are respectively arranged on two opposite surfaces of the substrate.

With reference to the first aspect, the embodiments of the present disclosure provide the first possible implementation of the first aspect, wherein the touch electrodes in the same partition are only provided on one surface of the substrate.

With reference to the first aspect, the embodiments of the present disclosure provide a second possible implementation of the first aspect, wherein the touch electrodes include several row touch electrodes and several column touch electrodes.

In combination with the second possible implementation of the first aspect, an embodiment of the present disclosure provides a third possible implementation of the first aspect, wherein the left and right edges of each partition are provided with first wiring areas,

wherein several row touch electrode wires for connecting the row touch electrodes are collected in the first wiring area; and

several column touch electrode wires for connecting the column touch electrodes are collected (gathered) in the first wiring area.

In combination with the third possible implementation of the first aspect, an embodiment of the present disclosure provides a fourth possible implementation of the first aspect, wherein the several row touch electrodes are wired from the first wiring area on the left edge of the partition, and the other several row touch electrodes are wired from the first wiring area on the right edge of the partition; and the several column touch electrodes are wired from the first wiring area on the left edge of the partition, and the other several column touch electrodes are wired from the first wiring area on the right edge of the partition.

In combination with the second possible implementation of the first aspect, an embodiment of the present disclosure provides a fifth possible implementation of the first aspect, wherein each of the partitions is provided with a first wiring area and a second wiring area, wherein the first wiring area is arranged at the left and right edges of the partition, and the second wiring area is arranged at a position of the longitudinal axis of the partition,

wherein the several row touch electrodes are wired from the first wiring area on the left edge of the partition, the several row touch electrodes are wired from the first wiring area on the right edge of the partition, and the several row touch electrodes are wired from the second wiring area; the several column touch electrodes are wired from the first wiring area on the left edge of the partition, and the several column touch electrodes are wired from the first wiring area on the right edge of the partition; and the several column touch electrodes are wired from the second wiring area.

In combination with the fifth possible implementation of the first aspect, an embodiment of the present disclosure provides a sixth possible implementation of the first aspect, wherein a third wiring area is provided on the top or bottom edge of each partition, wherein the column touch electrodes of each of the partitions are connected to the gate driving circuit via the third wiring area.

In combination with the sixth possible implementation of the first aspect, an embodiment of the present disclosure provides a seventh possible implementation of the first aspect, wherein the width of the third wiring area is not greater than width of the second wiring area.

With reference to the first aspect, the embodiments of the present disclosure provide the eighth possible implementation of the first aspect, wherein the touch panel includes three partitions, wherein the two partitions arranged at intervals are located on the same surface of the substrate, and the corresponding row touch electrodes in the two partitions on the same surface are connected by a first external wiring; and the corresponding column touch electrodes in the two partitions on the same surface are connected by a second external wiring.

With reference to the first aspect, the embodiments of the present disclosure provide the ninth possible implementation of the first aspect, wherein the first external wiring and/or the second external wiring are arranged outside the substrate along the outer edge of the partition.

With reference to the first aspect, the embodiments of the present disclosure provide the tenth possible implementation of the first aspect, wherein the touch electrode is in a diamond shape, a strip shape, or a grid shape.

With reference to the first aspect, the embodiments of the present disclosure provide the eleventh possible implementation of the first aspect, wherein the material of the substrate is glass or PI (polyimide).

With reference to the first aspect, the embodiments of the present disclosure provide the eighth possible implementation of the first aspect, wherein the material of the touch electrode is ITO (indium tin oxides).

In the second aspect, an embodiment of the present disclosure also provides a touch screen, including: a touch chip, a flexible circuit board, and the touch panel according to any one of the first aspect and its possible implementations, wherein the touch chip is connected to the touch electrodes in the touch panel through the flexible circuit board.

In a third aspect, an embodiment of the present disclosure further provides a display device, including the touch screen described in the second aspect.

The embodiments of the present disclosure have the following beneficial effects: an embodiment of the present disclosure provides a touch panel, including a substrate and touch electrodes disposed on the substrate, wherein the touch panel is divided into at least two partitions and the touch electrodes in adjacent partitions are respectively arranged on two opposite surfaces of the substrate. By partitioning the touch panel (or split screen) and the method of partitioned wiring, the technical solution provided by the embodiments of the present disclosure can reduce the difference between the lengths of the frame wiring, so as to prevent severe signal attenuation caused by a too long circuit, and to effectively reduce the signal interference, such that the problem that the prior touch screen has low touch sensitivity is solved, and the touch sensitivity is improved. In addition, the touch panel can use the substrate with high impedance, which improves the display effect.

Other features and advantages of the present disclosure will be described in the following description, and partly become obvious from the description, or be understood by implementing the present disclosure. The purpose and other advantages of the present disclosure are realized and obtained by the structures specifically pointed out in the description, claims and drawings.

In order to make the above-mentioned objectives, features and advantages of the present disclosure more obvious and understandable, the preferred embodiments in combination with accompanying drawings are described in detail as follows.

### BRIEF DESCRIPTION OF DRAWINGS

In order to more clearly illustrate the technical solutions in specific embodiments of the present disclosure or in the prior art, drawings which need to be used in the description of specific embodiments or the prior art will be introduced briefly below, and apparently, the drawings in the description below merely show some embodiments of the present disclosure, and a person ordinarily skilled in the art still could obtain other drawings in light of these drawings without inventive efforts.

FIG. 1 is a schematic diagram of an existing single-layer multi-point touch screen;

FIG. 2 is a sectional view of a touch panel provided by an embodiment of the present disclosure;

FIG. 3 is a top view of a touch panel provided by an embodiment of the present disclosure;

FIG. 4 is a comparison diagram of the wiring lengths of the column touch electrode before and after the split screen, where (a) represents the wiring length of the touch electrode before the split screen; (b) represents the wiring length of the column touch electrodes after the split screen;

FIG. 5 is a partial enlarged view of the top of the touch panel provided by an embodiment of the present disclosure;

FIG. 6 is a partial enlarged view of the bottom of the touch panel provided by an embodiment of the present disclosure;

FIG. 7 is a partial enlarged view of the middle portion of the touch panel provided by an embodiment of the present disclosure;

FIG. 8 is a schematic diagram of the connection of the split screen area of the touch panel provided by the embodiment of the present disclosure;

FIG. 9 is a schematic diagram of the wiring width of a touch panel provided by an embodiment of the present disclosure; and

FIG. 10 is a schematic diagram of a touch screen provided by an embodiment of the present disclosure.

### DETAILED DESCRIPTION OF EMBODIMENTS

In order to make the objectives, technical solutions and advantages of the embodiments of the present disclosure clearer, the technical solutions in the present disclosure will be described clearly and completely below in combination with the accompanying drawings, apparently, the embodiments described are merely some but not all embodiments of the present disclosure. Based on the embodiments of the present disclosure, all other embodiments obtained by those of ordinary skill in the art without inventive effort shall fall within the protection scope of the present disclosure.

At present, touch screens mostly are in single-layer multi-point touch screen structure, as shown in FIG. 1, because of the cost and thickness advantages of single-layer multi-point touch screen structure. However, due to the twists and turns of the wiring and the very large difference between the lengths of the wirings between different channels, the signal attenuation is severe, resulting in low touch sensitivity of the touch screen. In addition, the pattern of the single-layer multi-point touch screen structure also has wiring channels. The above-mentioned signal attenuation will cause the chip (IC) to be unable to distinguish the voltage changes between the pattern and the wiring, which amplifies the interference between signals, resulting in phenomena of touch by mistake and insensitivity. Based on this, the touch panel, touch screen, and display device provided by the embodiments of the present disclosure can solve the technical problem of low touch sensitivity in the prior art, and improve the sensitivity of touch.

In order to facilitate the understanding of this embodiment, a touch panel disclosed in the embodiment of the present disclosure is first introduced in detail.

### First Embodiment

The embodiment of the present disclosure provides a touch panel, which can be applied to a touch screen, and is specifically applied to a capacitive touch screen.

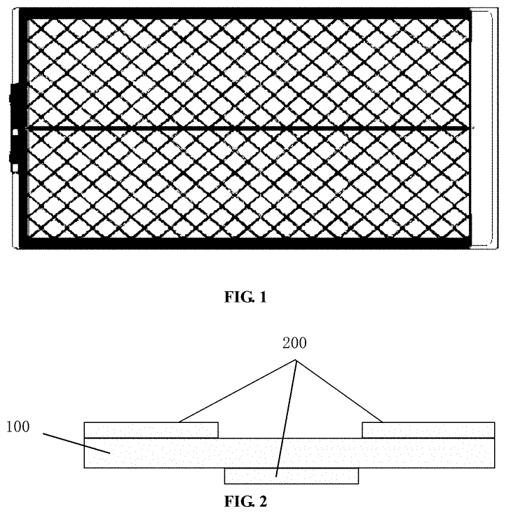

As shown in FIG. 2, the touch panel includes a substrate 100 and touch electrodes disposed on the substrate, wherein the touch panel is divided into at least two partitions 200 and the touch electrodes in adjacent partitions are respectively arranged on two opposite surfaces of the substrate.

Specifically, the substrate can be made of a rigid substrate such as glass or a flexible substrate such as PI (polyimide), and the touch electrode can be made of an oxide conductive film.

The touch electrodes in the partition (sub-area) are wired in the partition. Specifically, when the touch panel is divided into two adjacent partitions, the touch electrodes in the two partitions are respectively connected through internal wiring channels in the partition where they are located; when the touch panel is divided into at least three partitions, there must be at least two different partitions located on the same surface. In this case, the touch electrodes between at least two different partitions on the same surface can be connected by external connecting wires. By providing the partitions and the wiring method of the partition connection, the distance difference between the wirings is reduced, and the signal power attenuation and severe signal interference caused by the excessively long circuit are prevented, which is beneficial to improve the touch sensitivity.

It should be noted that the number of partitions can be determined according to the signal attenuation of the touch screen to be controlled actually, that is, a reasonable number of partitions can ensure that the signal attenuation is within a reasonable range and improve the sensitivity of touch.

The touch panel provided by the embodiment of the present disclosure includes a substrate and touch electrodes disposed on the substrate, wherein the touch panel is divided into at least two partitions and the touch electrodes in adjacent partitions are respectively arranged on two opposite surfaces of the above substrate. The touch panel uses a split screen method to control the attenuation of the signal within a preset range, which improves the sensitivity of touch. Moreover, the touch panel adopts a partitioned wiring method, which can reduce the difference between the lengths of the frame wiring, so as to prevent severe signal attenuation caused by a too long circuit, and to effectively reduce the signal interference, such that the problem that the prior touch screen has low touch sensitivity is solved, and the touch sensitivity is improved. In addition, the touch panel can use a substrate with a large impedance, so as to avoid the problem that the display effect of the existing touch screen is reduced by reducing the impedance of the film material in order to improve the sensitivity, which can increase the transmittance of the touch screen and thus improve the display effect.

Further, the touch electrodes in the same partition are only arranged on one surface of the substrate. In other words, taking one partition as an example, the touch electrodes of the partition are only arranged on one surface of the substrate, and the other surface of the substrate is not provided with the touch electrodes of the partition, that is, the touch electrodes of the partition provided on the other surface of the substrate have been emptied.

Further, the above-mentioned partitions are all arranged in the window area (or view area) (VA area) of the touch panel, that is, the window area of the touch panel is partitioned.

Further, the above touch electrode is in a diamond shape, a strip shape, or a grid shape. In this embodiment, the touch electrode is in a diamond shape.

Considering how to improve the display effect, further, the material of the substrate here is glass.

In view of the oxide conductive film, the Sn-doped In2O3 (i.e., ITO) film has the highest transmittance and the best conductivity, and it is easy to etch fine patterns in the acid solution, and the light transmittance is more than 90%. Further, the material of the touch electrode is ITO. The light transmittance and resistance of ITO are respectively controlled by the ratio of In2O3 to SnO2, generally, SnO2: In2O3=1:9.

By selecting glass as the material of the substrate and ITO as the material of the touch electrode, the screen has a higher transmittance, thereby improving the display effect of the touch screen.

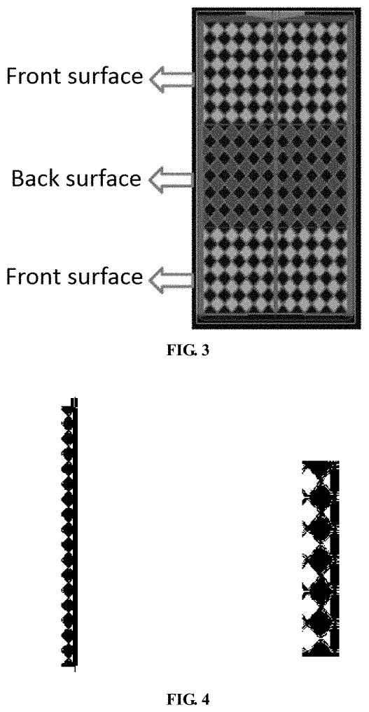

For ease of understanding, the touch panel provided in this embodiment will be briefly described in conjunction with FIG. 3.

The touch panel includes three partitions, two of which are located on the front surface of the substrate (the touch electrodes of the two partitions are only provided on the front surface (front side) of the substrate), and the other partition is located on the back surface (reverse side) of the substrate (that is, the touch electrodes of the other partition are only provided on the back surface of the substrate); and the substrate is made of glass, the touch electrode is made of ITO, and the touch electrode is diamond-shaped.

FIG. 4 shows a comparison diagram of the wiring lengths of the column touch electrode before and after the split screen, where (a) represents the wiring length of the column touch electrodes before the split screen, (b) represents the wiring length of the column touch electrodes after the split screen, as can be seen from FIG. 4, by split screen for the touch panel, the wiring length is greatly reduced.

It should be noted that the touch electrodes (or patterned ITO) arranged on the front surface of the substrate in the partition on the back surface of the substrate have been emptied to prevent that the signal is shielded and the signal triggered by finger cannot be sensed.

Further, as shown in FIGS. 5, 6 and 7, the touch electrodes include several row touch electrodes 300 and several column touch electrodes 400.

Specifically, each partition includes row touch electrodes 300 (also called Tx electrodes or X-axis electrodes) and column touch electrodes 400 (also called Rx electrodes or Y-axis electrodes); row touch electrodes and column touch electrodes are diamond-shaped. Among them, when there are two split screen areas, the row touch electrodes and column touch electrodes in the split screen areas are respectively connected by internal wiring channels in the split screen areas; when there are at least three split screen areas, row touch electrodes and column touch electrodes in each split screen area are respectively connected by internal wiring channels in the split screen area, and the row touch electrodes and column touch electrodes between the split screen areas on the same surface are connected by external connecting wires, respectively.

In an embodiment, the left and right edges of each partition are provided with first wiring areas (also called edge wiring areas), wherein several row touch electrode wires 301 (also called the first internal wiring channels) used to connect the row touch electrodes are collected in the first wiring area; and several column touch electrode wires 401 (also called the second internal wiring channels) used to connect the column touch electrodes are collected in the first wiring area.

Further, the several row touch electrodes are wired from the first wiring area on the left edge of the partition, and the other several row touch electrodes are wired from the first wiring area on the right edge of the partition; and the several column touch electrodes are wired from the first wiring area on the left edge of the partition, and the other several column touch electrodes are wired from the first wiring area on the right edge of the partition. In other words, the above-mentioned first wiring area includes a left wiring area and a right wiring area; the row touch electrodes include several row touch electrodes wired on the left and several row touch electrodes wired on the right; and similarly, the column touch electrodes include several column touch electrodes wired on the left and several column touch electrodes wired on the right.

Specifically, taking a position at ½ of the partition width (along the X direction) as the boundary, the row touch electrodes in the left half are wired from the left side of the first wiring area, and the row touch electrodes in the right half are wired from the right side of the first wiring area; and the column touch electrodes in the left half are wired from the left side of the first wiring area, and the column touch electrodes in the right half are wired from the right side of the first wiring area.

It should be pointed out that in view of the fact that the row touch electrodes (or column touch electrodes) at the boundary are divided into two, at this time, the row touch electrodes (or column touch electrodes) at the boundary can be wired from the first wiring area on the left or from the first wiring area on the right, which is not limited in this disclosure.

In another embodiment, a second wiring area (also called a middle wiring area) is provided in the middle portion of each partition (specifically, the position of the longitudinal axis), wherein several row touch electrode wires for connecting the row touch electrodes are gathered in the second wiring area; and/or, several column touch electrode wires for connecting the column touch electrodes are gathered in the second wiring area.

Specifically, the row touch electrodes on the right side of the second wiring area are wired from the second wiring area, and the row touch electrodes on the left side of the second wiring area are wired from the second wiring area; and similarly, the column touch electrodes on the right side of the second wiring area are wired from the second wiring area, and the column touch electrodes on the left side of the second wiring area are wired from the second wiring area.

Further, a third wiring area is provided on the top or bottom edge of each partition, wherein the column touch electrodes of each of the partitions are connected to the gate driving circuit via the third wiring area.

It should be noted that the width of the third wiring area is not greater than the width of the second wiring area.

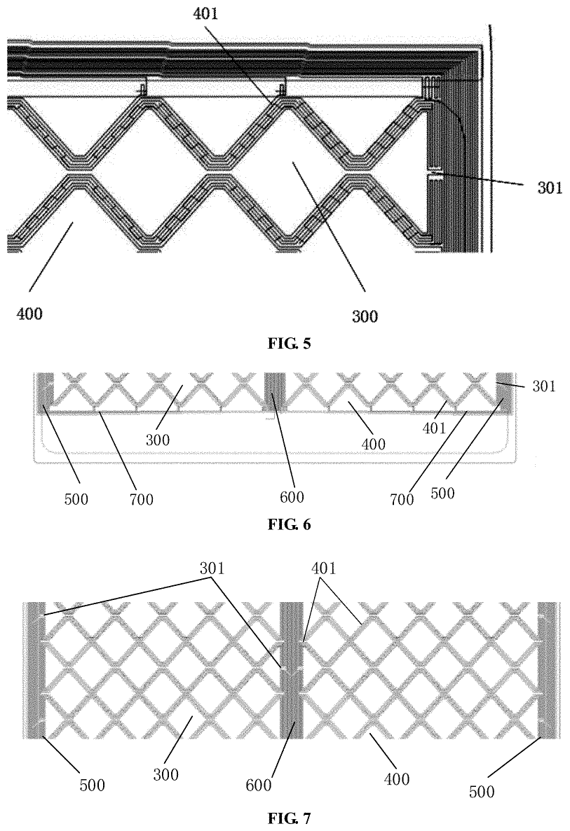

In this embodiment, referring to FIGS. 6 and 7, the partition is provided with a first wiring area 500 and a second wiring area 600, wherein the first wiring area is arranged at the edges of the partition, and the second wiring area is arranged at a position of the longitudinal axis of the partition,

wherein the several row touch electrodes are wired from the first wiring area on the left edge of the partition, the several row touch electrodes are wired from the first wiring area on the right edge of the partition, and the several row touch electrodes are wired from the second wiring area; the several column touch electrodes are wired from the first wiring area on the left edge of the partition, and the several column touch electrodes are wired from the first wiring area on the right edge of the partition; and the several column touch electrodes are wired from the second wiring area.

Specifically, the first wiring area is provided on the left and right edges of the partition, and the second wiring area is provided at ½ of the width (along the X axis direction) of the split screen area and perpendicular to the X axis, the row touch electrodes in the left half of one of the two adjacent rows of touch electrodes are wired from the left side of the first wiring area, and the row touch electrodes in the right half of one of the two adjacent rows of touch electrodes are wired from the right side of the first wiring area; the row touch electrodes in the left half of the other row of two adjacent rows of touch electrodes are wired from the second wiring area, and the row touch electrodes in the right half of the other row of two adjacent rows of touch electrodes are wired from the second wiring area; and the column touch electrodes in the same column are connected in series in sequence, the column touch electrode wires in each column are snake-shaped (or caterpillar-shaped), and the column touch electrode wires are wired along the edges of the row touch electrodes, that is to say, the wiring of the column touch electrode wire is close to the edge of the row touch electrode.

Specifically, the column touch electrode wires include a first fold line part, a second straight line part, a third fold line part, and a fourth straight line part that are connected in sequence, wherein the first fold line part and the third fold line part are parallel to each other, the second straight line part and the fourth straight line part are parallel to each other, the first fold line part and the second straight line part are perpendicular to each other, the first fold line part and the third fold line part are in a fold line shape along the edges of the row touch electrodes of the adjacent rows, and the second straight line part is located in the first wiring area and is in straight line shape; and the fourth straight line part is located in the second wiring area and is in straight line shape. One end of the column touch electrodes in the left half is wired from the left side of the first wiring area, and the other end of the column touch electrodes in the left half is wired from the second wiring area; and one end of the column touch electrodes in the right half is wired from the right side of the first wiring area, and the other end of the column touch electrodes in the right half is wired from the second wiring area.

It should be pointed out that in view of the fact that the row touch electrodes (or column touch electrodes) adjacent to the second wiring area are divided into two, at this time, the row touch electrodes (or column touch electrodes) at the boundary can be wired from the first wiring area on the left or from the first wiring area on the right, which is not limited in this disclosure.

As shown in FIG. 6, in this embodiment, a third wiring area 700 is provided on the bottom edge of partition, wherein the column touch electrodes of the partition are connected to the gate driving circuit via the third wiring area.

The width of the third wiring area 700 is smaller than the width of the second wiring area. In other words, the bottom wiring of the partition is not greater than the wiring in the middle of the pattern in width, where the width of the wiring in the middle of the pattern can be a threshold that can avoid touch blind areas.

Further, when the number of split screen areas is greater than 2, row touch electrodes and column touch electrodes of different partitions on the same surface can be connected correspondingly, respectively, to reduce the width of the frame.

Specifically, referring to FIG. 8, the touch panel includes three partitions, wherein two partitions arranged at intervals are located on the same surface (front surface) of the substrate, one partition is located on the other surface (back surface) of the substrate, and the one partition separates the two partitions, and there is no touch electrode (i.e., the ITO is emptied) on the surface of the substrate opposite to the one partition on the back surface (that is, the front surface of the substrate where the two partitions are located). In the above, the corresponding row touch electrodes in the two partitions on the same surface are connected by a first external wiring; and the corresponding column touch electrodes in the two partitions on the same surface are connected by a second external wiring.

It should be noted that the first external wiring and/or the second external wiring are arranged outside the substrate along the outer edge of the partition.

As shown in FIG. 8, the corresponding row touch electrodes in the left half of the two partitions on the same surface: Tx01 and Tx11, Tx02 and Tx12, Tx03 and Tx13, and Tx04 and Tx14 are respectively connected by the first external wiring. In this way, the split screen distance is far enough and greater than the distance of one finger, so it will not have an adverse effect on the touch, and thus the touch effect is improved.

At the same time, the corresponding row touch electrodes in the left half of the two partitions on the same surface: Rx01 and Rx11, Rx02 and Rx12, Rx03 and Rx13, and Rx04 and Rx14 are connected by the second external wiring, so as to reduce the number of RX wiring channels.

It should be understood that the corresponding row touch electrodes in the right half of the two partitions on the same surface: Tx05 and Tx15, Tx06 and Tx16, Tx07 and Tx17, and Tx08 and Tx18 are respectively connected by the first external wiring; and the corresponding row touch electrodes in the right half of the two partitions of the same surface: Rx05 and Rx15, Rx06 and Rx16, Rx07 and Rx17, and Rx08 and Rx18 are connected by a second external wiring.

It should be noted that the wiring of the partition on the back surface is similar to the wiring of the partition on the front surface. The only difference is that the touch electrodes in the partition on the back surface of the substrate are wired on the back surface.

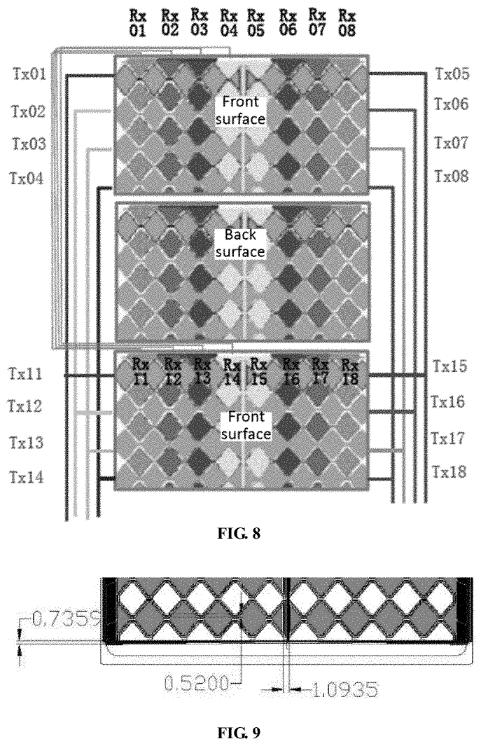

As shown in FIG. 9, the wiring width of the pattern of all the column touch electrode wires in this embodiment is 0.5200 mm, and the bottom wiring width of the column touch electrode in the partition (for short, the bottom wiring of the split screen) is 0.7359 mm, and the width of the second wiring area (that is, the wiring width in the middle of the pattern) is 1.0935 mm. It can be seen that, since the scheme of double-sided outgoing line is no longer required, it can be ensured that the bottom wiring of the split screen is not larger than the wiring in the middle of the pattern in width.

### Second Embodiment

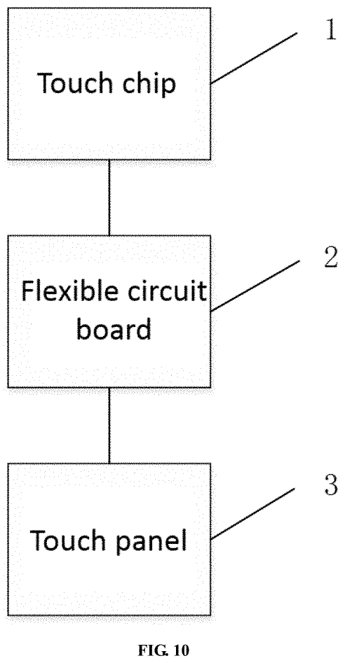

FIG. 10 shows a schematic diagram of a touch screen provided by an embodiment of the present disclosure. Referring to FIG. 10, the touch screen includes: a touch chip 1, a flexible circuit board 2 and a touch panel 3 mentioned in the above embodiment, wherein the touch chip is connected to the touch electrodes in the touch panel through the flexible circuit board.

Further, the touch screen is a capacitive touch screen.

The touch screen provided in the embodiment of the present disclosure has the same technical features as the touch panel provided in the foregoing embodiment, so it can also solve the same technical problem and achieve the same technical effect.

An embodiment of the present disclosure also provides a display device, including the above-mentioned touch screen.

Further, the display device further includes a display screen, and the display screen is arranged below the touch screen.

Further, the display device may be a mobile device such as a smart phone, a tablet computer, a notebook computer, and wearable devices.

The implementation principles and technical effects achieved of the touch screen and display device provided in the embodiments of this disclosure are the same as those of the foregoing method embodiments. For a brief description, for the parts not mentioned in the device embodiments, reference can be made to the corresponding content in the foregoing touch panel.

In all the examples shown and described herein, any specific value should be interpreted as merely exemplary, rather than as a limitation, and therefore, other examples of the exemplary embodiment may have different values.

It should be noted that similar reference signs and letters indicate similar items in the following drawings. Therefore, once a certain item is defined in one drawing, it does not need to be further defined and explained in the subsequent drawings.

In addition, in the description of embodiments of the present disclosure, unless otherwise specified and defined clearly, the terms “mount”, “join”, and “connect” should be understood in a broad sense, for example, a connection can be a fixed connection, a detachable connection, or an integrated connection; it can be a mechanical connection or an electrical connection; it can be a direct connection or an indirect connection through an intermediate medium, and it also can be an inner communication between two elements. For a person ordinarily skilled in the art, specific meanings of the above-mentioned terms in the present disclosure could be understood according to specific circumstances.

In the description of the present disclosure, it should be indicated that orientation or positional relationships indicated by terms “center”, “upper”, “lower”, “left”, “right”, “vertical”, “horizontal”, “inner”, “outer” and so on are based on orientation or positional relationships as shown in the accompanying drawings, merely for facilitating describing the present disclosure and simplifying the description, rather than indicating or suggesting that related devices or elements have to be in the specific orientation or configured or operated in a specific orientation, and therefore, they should not be construed as limitation on the present disclosure. Besides, terms “first”, “second”, and “third” are merely for descriptive purpose, but should not be construed as indicating or implying relative importance.

Finally, it should be noted that the above-mentioned embodiments are only specific implementations of the present disclosure, which are used to illustrate the technical solution of the present disclosure, rather than limit it. The scope of protection of the present disclosure is not limited thereto, although the present disclosure has been described in detail with reference to the foregoing embodiments, those of ordinary skill in the art should understand that any person skilled in the art, within the scope of the technology disclosed in the present disclosure, can still make modifications or easily conceived changes to the technical solutions described in the foregoing embodiments, or equivalently replace some of the technical features therein; and these modifications, changes or replacements do not cause the essence of the corresponding technical solutions to deviate from the spirit and scope of the technical solutions of the embodiments of the present disclosure, and should be covered within the protection scope of the present disclosure. Therefore, the protection scope of the present disclosure shall be subject to the protection scope of the claims.

1. A touch panel, comprising a substrate and touch electrodes disposed on the substrate, wherein the touch panel is divided into at least two partitions and the touch electrodes in adjacent partitions are arranged on two opposite surfaces of the substrate, respectively.

2. The touch panel according to claim 1, wherein the touch electrodes in the same partition are only arranged on one surface of the substrate.

3. The touch panel according to claim 1, wherein the touch electrodes comprise several row touch electrodes and several column touch electrodes.

4. The touch panel according to claim 3, wherein first wiring areas are provided on left and right edges of each of the partitions;
wherein several row touch electrode wires configured to connect the row touch electrodes are collected in the first wiring areas; and
several column touch electrode wires configured to connect the column touch electrodes are collected in the first wiring areas.

5. The touch panel according to claim 4, wherein several row touch electrodes are wired from the first wiring areas on left edges of the partitions, and the other several row touch electrodes are wired from the first wiring areas on right edges of the partitions; and several column touch electrodes are wired from the first wiring areas on the left edges of the partitions, and the other several column touch electrodes are wired from the first wiring areas on the right edges of the partitions.

6. The touch panel according to claim 3, wherein each of the partitions is provided with first wiring areas and a second wiring area, wherein the first wiring areas are arranged at left and right edges of a partition, and the second wiring area is arranged at a position of longitudinal axis of the partition,
wherein several row touch electrodes are wired from a first wiring area on a left edge of the partition, and several row touch electrodes are wired from a first wiring area on a right edge of the partition; several row touch electrodes are wired from the second wiring area; several column touch electrodes are wired from the first wiring area on the left edge of the partition, and several column touch electrodes are wired from the first wiring area on the right edge of the partition; and several column touch electrodes are wired from the second wiring area.

7. The touch panel according to claim 6, wherein a third wiring area is provided on top or bottom edge of each of the partitions, wherein the column touch electrodes of each of the partitions are connected to a gate driving circuit via the third wiring area.

8. The touch panel according to claim 7, wherein a width of the third wiring area is not greater than a width of the second wiring area.

9. The touch panel according to claim 1, wherein the touch panel comprises three partitions, wherein two partitions arranged at intervals are located on the same surface of the substrate, and corresponding row touch electrodes in the two partitions on the same surface are connected by a first external wiring; and corresponding column touch electrodes in the two partitions on the same surface are connected by a second external wiring.

10. The touch panel according to claim 1, wherein the first external wiring and/or the second external wiring are arranged outside the substrate along outer edges of the partitions.

11. The touch panel according to claim 1, wherein the touch electrodes are of a diamond shape, a strip shape or a grid shape.

12. The touch panel according to claim 1, wherein a material of the substrate is glass or PI.

13. The touch panel according to claim 1, wherein a material of the touch electrodes is ITO.

14. A touch screen, comprising a touch chip, a flexible circuit board and the touch panel according to claim 1, wherein the touch chip is connected to the touch electrodes in the touch panel through the flexible circuit board.

15. A display device, comprising the touch screen according to claim 14.
